(19) United States
(12) Patent Application Publication
(10) Pub. No.: US 2014/0176340 A1
(43) Pub. Date: Jun. 26, 2014

(54) METHOD AND SYSTEM FOR POWERLINE TO MESHED NETWORK FOR POWER METER INFRA-STRUCTURE

(71) Applicant: Jetlun Corporation, South San Francisco, CA (US)

(72) Inventors: Ray LIANG, Shenzhen (CN); Tat-Keung CHAN, South San Francisco, CA (US); Elsa A. CHAN, South San Francisco, CA (US)

(73) Assignee: Jetlun Corporation, South San Francisco, CA (US)

(21) Appl. No.: 14/135,476

(22) Filed: Dec. 19, 2013

Related U.S. Application Data
(60) Provisional application No. 61/745,223, filed on Dec. 21, 2012.

(51) Int. Cl. G01D 4/00; H04L 9/06; H04W 4/00

(52) U.S. Cl. CPC G01D 4/002; H04W 4/005; H04L 9/0631
USPC 340/870.02

(57) ABSTRACT

A transparent networking system for meter infrastructure within a network. The system has a single transparent meshed communication network comprising a first ZigBee network provided within a first spatial region and a second ZigBee network provided within a second spatial region. The network has a powerline carrier configured between the first ZigBee network and the second ZigBee network to facility transfer of bi-directional information packet by packet between the first ZigBee network and the second ZigBee networks.

### CROSS REFERENCE TO RELATED APPLICATIONS

This application claims priority to U.S. Ser. No. 61/745,223 (Attorney Docket No. A902RO-001600US) filed Dec. 21, 2012, commonly assigned, and is hereby incorporated by reference herein, and is related to U.S. Ser. No. 14/031,693 (Attorney Docket No. A902RO-001512US) filed Sep. 19, 2013, commonly assigned, and is hereby incorporated by reference for all purposes.

### BACKGROUND OF THE INVENTION

Power utilities all over the world are heavily investing and deploying Smart Meters to enable two-way meter reading. As an extension of automatic meter infrastructure, termed “AMI,” power utilities are investing in HAN solutions that will enable them to increase the awareness of energy usage among its customers in an effort to be able to charge its customers Time-of-Use (TOU) rates and manage its loads to prevent rolling black outs or brown outs due to peak usage. Wireless is currently the technology of choice among power utilities as the connectivity solution from under the glass of the Smart Meter to the HAN devices in the home. Although wireless is sufficient in most single-family homes, it becomes more challenging due to range and interferences in various environments such as multi-dwellings buildings, rural areas where the Smart Meter is far from the house as well as homes that are built with cement or steel frame.

From the above, it is seen that techniques for improving AMI and how the Smart Meter connects to HAN is highly desirable.

### BRIEF SUMMARY OF THE INVENTION

The present invention relates to power meter techniques.

In a specific embodiment, the present invention provides a transparent networking system for energy management within a network. The system has a single transparent meshed communication network. The network includes a first ZigBee network provided within a first spatial region, which is within a confinement of a first thirty meter range. The network includes a second ZigBee network provided within a second spatial region, which is within a confinement of a second thirty meter range. The network has a powerline carrier configured between the first ZigBee network and the second ZigBee network to facility transfer of bi-directional information packet by packet between the first ZigBee network and the second ZigBee networks.

In an alternative specific embodiment, the present invention provides a transparent networking system for meter infrastructure within a network. The system has a single transparent meshed communication network comprising a first ZigBee network provided within a first spatial region and a second ZigBee network provided within a second spatial region. The network has a powerline carrier configured between the first ZigBee network and the second ZigBee network to facility transfer of bi-directional information packet by packet between the first ZigBee network and the second ZigBee networks.

In yet an alternative embodiment, the present invention provides a method for communicating within a single transparent meshed network. The method includes initializing a first sniffer device in the first ZigBee network, initializing a second sniffer device in the second ZigBee network, initializing a first powerline driver, initializing a second powerline driver, and scanning the first ZigBee network through a plurality of first channels using a first switching operation. The method includes selecting a first channel for the first ZigBee network by the first switching operation through the plurality of channels, the first channel being from the plurality of channels in the first ZigBee network. The method includes scanning the second ZigBee network through a plurality of second channels using a second switching operation and selecting a second channel for the second ZigBee network by the second switching operation through a plurality of channels. The second channel is from the plurality of channels in the second ZigBee network. The method includes recording information from the first ZigBee network and recording information from the second ZigBee network. The method includes sniffing each of the first ZigBee network and the second Zigbee network. The method includes receiving a data packet from a first ZigBee enabled device within the first ZigBee network and checking the data packet to parse a header of the data packet to determine whether to forward the data packet by comparing a plurality of entries in an address table of the first ZigBee network. The method includes transferring the data packet from the first ZigBee network to the second ZigBee network using a powerline carrier through a PHY/MAC layer.

In an example, each of ZigBee network, including sniffer device, configures communication on a specified channel/PAN ID. Each side of the ZigBee network configured with the powerline carrier parses and analyses the ZigBee packets on the 802.15.4 MAC layer, only the MAC frame header, which does not encrypt such as the frame type/PAN/address fields. Each side of the ZigBee networks records the address received, and notifies the other ZigBee network regarding the received information. In an example, one side of the ZigBee network will decide to forward the ZigBee packets to the other side depend on the aforementioned step, through the HomePlug™ powerline network, which encrypts using the HomePlug™ network password, which can be 128-bit AES.

Numerous benefits are achieved using the present invention over conventional techniques. The present invention maximizes the use of existing AC power lines of a home or building, provides a wireless extension for a smart meter to connect to devices in the home, and provide a backhaul wireless extension to connect to a AMI network. In a preferred embodiment, the present system provides a novel technique to communicate with one or more Smart Meters wirelessly and convert data over the existing AC power lines and revert the signal from the power lines back to a wireless network. In another preferred embodiment, the present system provides a novel technique to communicate with one or more smart meters from one type of wireless network to a powerline network and then to another type of wireless network. Depending upon the embodiment, one or more of these benefits may exist. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified system diagram according to an example in the present invention.

FIG. 2 is a simplified diagram of a first meshed network communicating via power line to a second meshed network in an example of the present invention.

FIG. 3 is an example of packet flow between multiple meshed networks in examples of the present invention.

FIG. 4 is an example of hardware and software in an example of the present invention.

FIG. 5 is an example of a protocol for a flow diagram of the present invention.

FIG. 6 is an illustration of a communication flow according to an example of the present invention.

FIG. 7 is a simplified illustration of an encryption technique according to an embodiment of the present invention.

### DETAILED DESCRIPTION OF THE INVENTION

According to the present invention, techniques related to the field of extending the meter infrastructure into a multi-dwelling and methods of repeating a wireless signal are provided. More particularly, the present invention provides methods and devices configured to use with Smart Metering and particularly to Home Area Networks, combinations of these and the like but it would be recognized that the invention has a broader range of applications.

In an example, ZigBee technology is using in applications such as smart energy, home automation, and others. Advantages include compatibility with large networks, network agility, multiple networking type, good interoperability, low power and low cost, and the like. Unfortunately, ZigBee technology is a kind of wireless communication technology that has some advantage but also has limitations. Such limitations include large signal attenuation through wall, path loss, frequency-selective fading and small coverage indoor, among others.

In MDU (Multiple Dwelling Unit) environments, the ZigBee network is limited in coverage outside of a home or building structure. If the ZigBee TC (Trust Center) is outside the home, the HAN (Home Area Network) device has difficulty communicating with the TC. Especially for smart energy deployment, smart meters have been installed in the meter room, which have difficulty communicating outside with the TC. In most examples, HAN devices in individual homes often need to talk to corresponding smart meters to get information or report status to be effective.

In an example, PLC (Powerline Communication) technology use exist power line for data transition between any two nodes within the powerline network. In an example, HomePlug™ is an industry standard of PLC technology and had been widely used in global. It has virtue such as longer distance, high bandwidth, low latency, high stability.

In an example, using the benefit of PLC technology, we propose bridging ZigBee networks through PLC to extend the network coverage for MDU or commercial environment. If bridging ZigBee network through PLC in application layer, then there are at least two ZigBee network in the application scenarios. It will affect current ZigBee network backend management system. To bridge one ZigBee network through PLC, it requires the bridge supports transparent bridging MAC (Media Access Control) layer packet between ZigBee and PLC network. A bridge listen all ZigBee packet in MAC layer through its RF radio and maintain an address/route table. It uses the table to determine whether to forward the captured ZigBee packet to other bridge through PLC. Once receive a ZigBee packet from PLC, a bridge will send out the packet in ZigBee MAC format through its RF radio. Both Bridge A and Bridge B are same in hardware and software architecture. The form factor can be different. Further details of the present method and system can be found throughout the present specification and more particularly below.

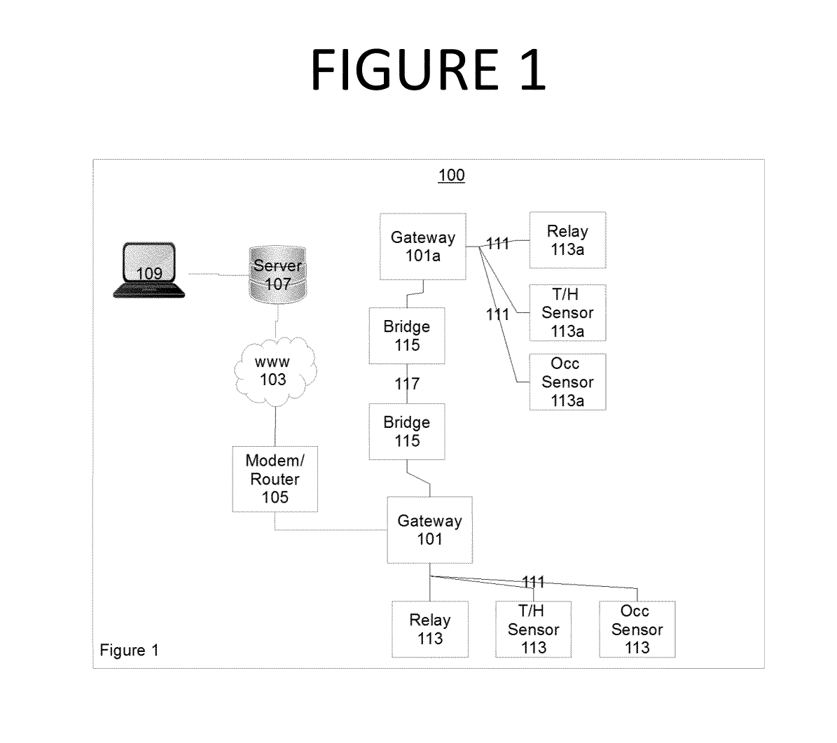

In an example, FIG. 1 is a simplified system diagram according to an embodiment in the present invention. This diagram is merely an example, which should not unduly limit the scope of the claims herein. One of the ordinary skills in the art would recognize many variations, alternatives, and modifications. As shown, the system 100 for an energy monitoring and control network is included. The system 100 has a gateway 101 that is coupled to the external data source 103, which is derived from a modem or router 105 that connects to a world-wide network of computers or world-wide web (WWW) 103 and is then coupled to the Jetlun cloud server 107 where user can access via any web-enabled device 109. The modem/router 105 assigns IP address to the gateway 100. The gateway 100 is then wirelessly or through powerline carrier technology 111 connected to sensors and control devices 113. A secondary gateway 101a is connected to the modem/router 105 via an network bridge 115 that is either communicating over coaxial wire or phone wire 117 to another network bridge 115 that is coupled to the Gateway 101.

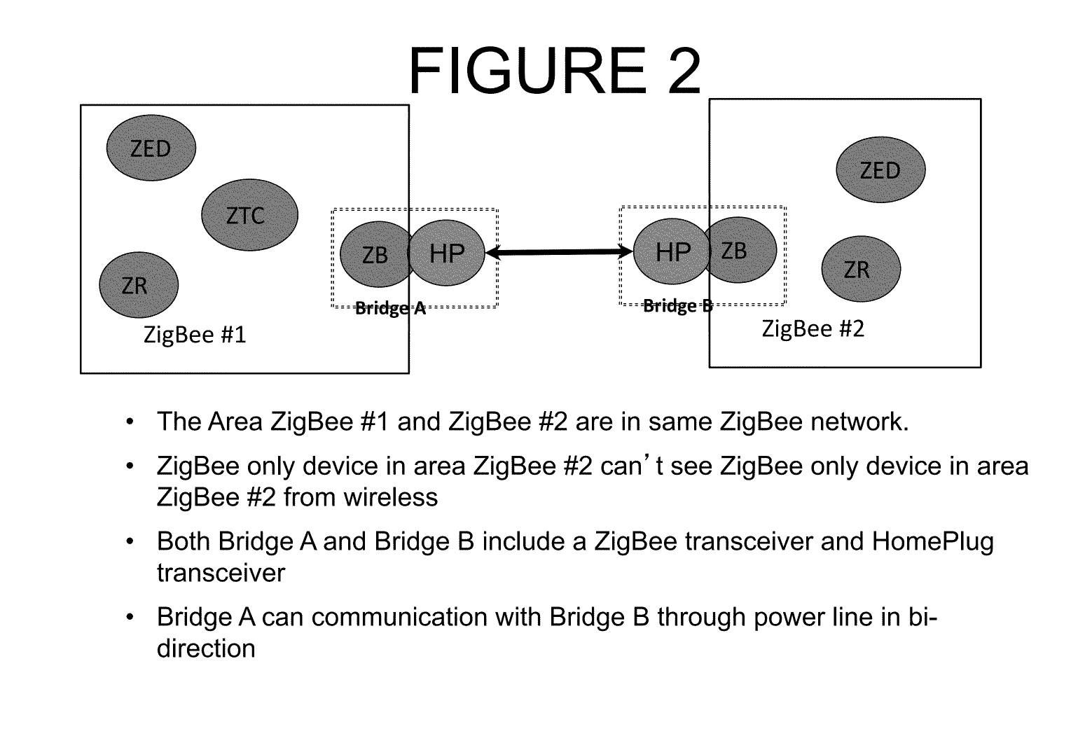

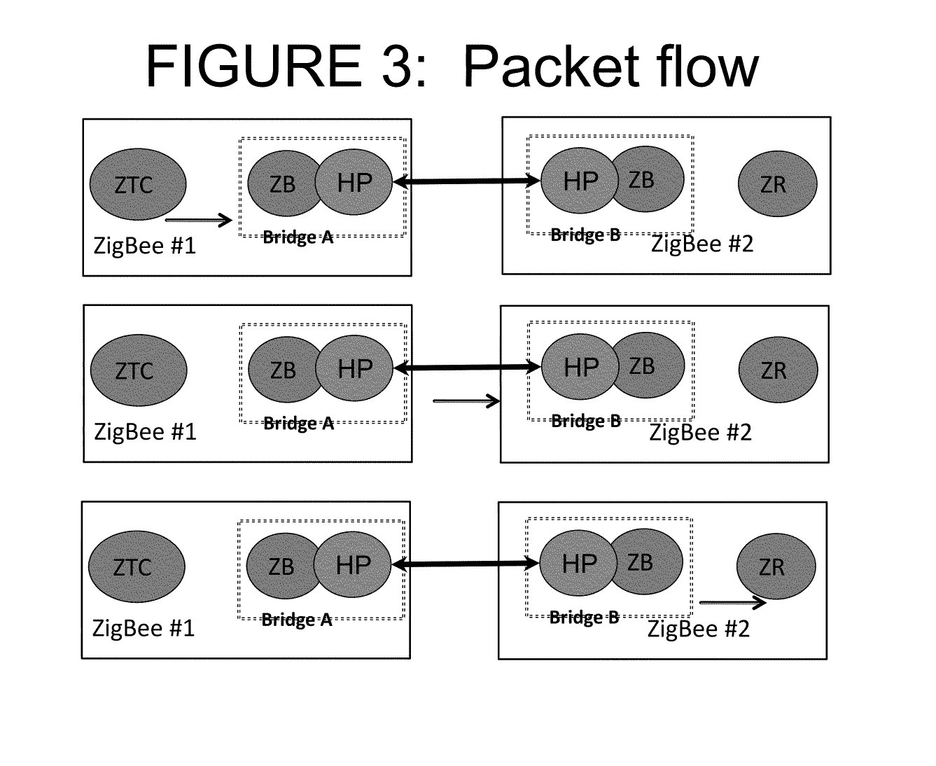

Referring to FIGS. 2 and 3, Bridge A and Bridge B should bridge two area network transparently and desirably does not bring any duplicate routing and packet in the network which may cause network storm or packet loss. In an example, any ZigBee device in area ZigBee #2 can join to the ZigBee network and talk to any ZigBee device in area ZigBee #1. In an example, any ZigBee device in area ZigBee #1 also can talk to any ZigBee device in area ZigBee #2. In an example, the aforementioned solutions would not limit to bridge two ZigBee sub-network. It can bridge more ZigBee sub-network with maximum sixteen (16) or more. Each sub-network has one and only one PLC to ZigBee bridge.

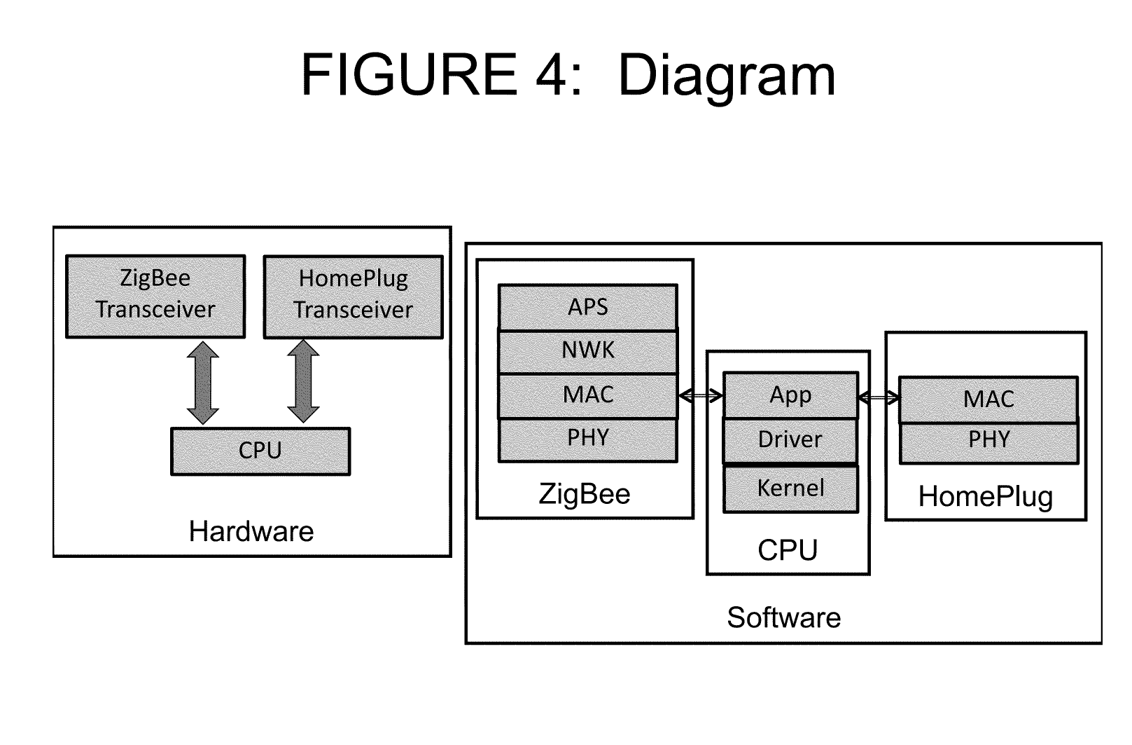

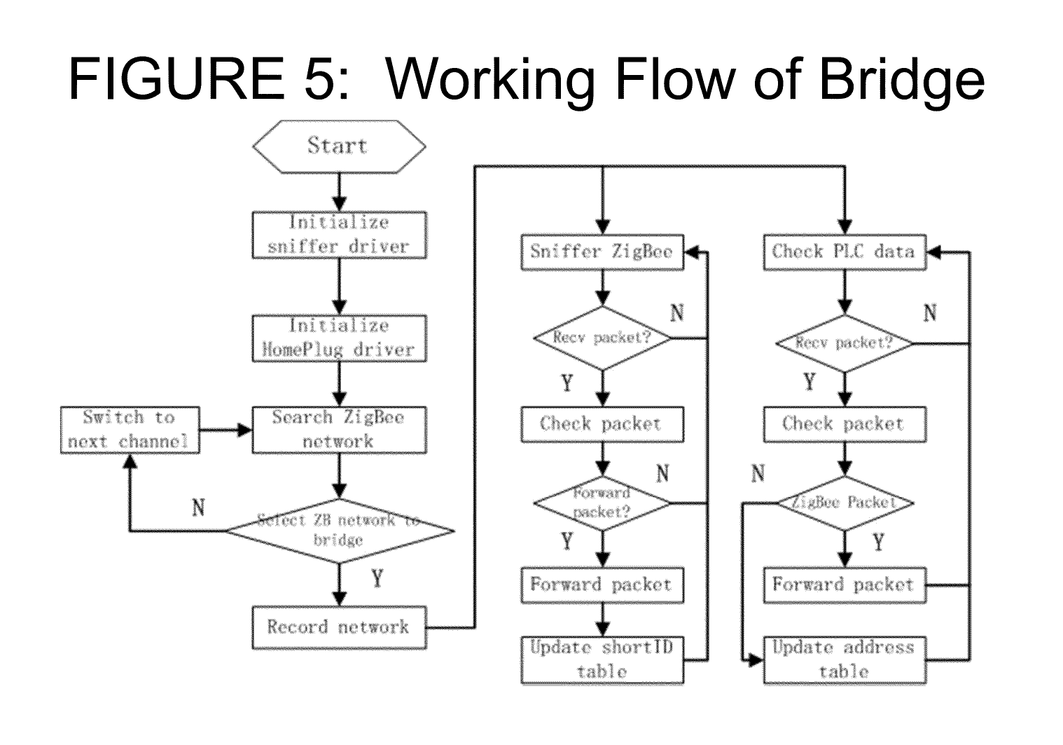

In an example referring to FIG. 4, and the other Figures, both Bridge A and Bridge B are same in hardware and software architecture. The form factor can be different, although they can be the same. In an example referring to FIG. 5, the PLC to ZigBee bridge does not need to join the ZigBee network. In an example, the PLC to ZigBee bridge sniffer ZigBee packet is in PHY/MAC layer. It only parse 802.15.4 header of the packet to maintain address/route table. It does not need to decrypt the packet in NWK (Network) or APS (Application Sub-layer) layer in an example. In an example, the address/route table is dynamic. Each entry in the table has aging time. In an example, the address/route table is used to determine whether to forward the sniffer ZigBee packet and where to forward. In an example, a PLC to ZigBee bridge should negotiate other bridge to select which ZigBee network they should bridge. In an example, when a PLC to ZigBee bridge receives a ZigBee packet from another ZigBee bridge, it should send out the packet to ZigBee network through ZigBee RF radio. In an example, the PLC to ZigBee bridge should notify all ZigBee node ID in its ZigBee sub-network to all other bridge once there is update. The notify should be acknowledged. Otherwise, should resend the notify.

In an example, Data Flow between ZigBee 1 to ZigBee 2 is illustrated by way of FIG. 2 as an example.

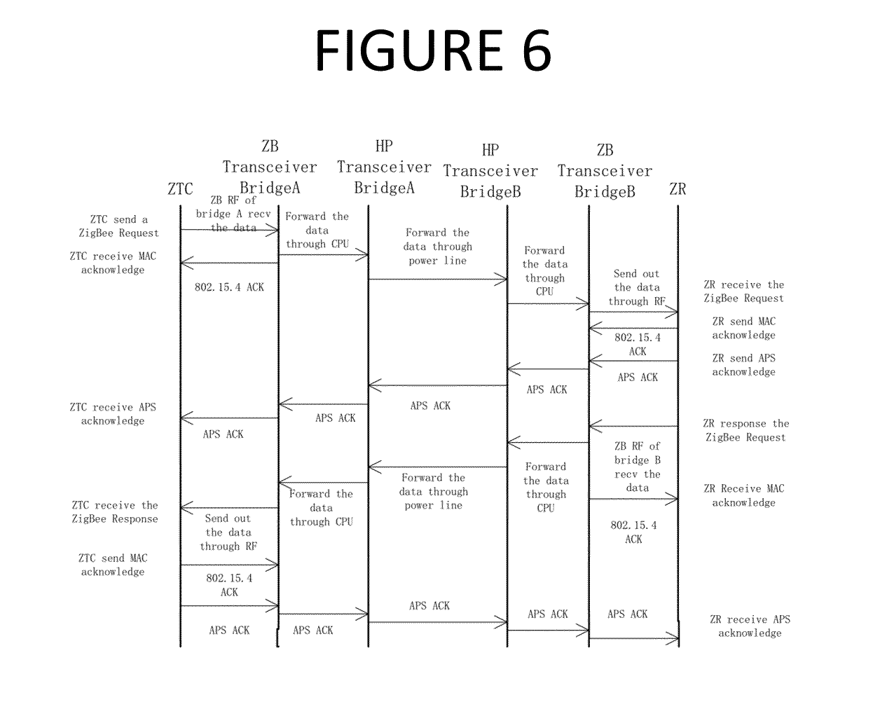

Referring to FIG. 6, the bridge will acknowledge the ZigBee it need to forward to HomePlug. It will meet the strict timing requirement on ZigBee MAC.

In an example, an address table is provided below, although there can be variations, modifications, and alternatives.

### Address Table

There are two address table in each bridge, one is source address table, the other is destination address. Below is the definition of the address table.

typedef struct {
int16 nShortID; //short ID of ZigBee node
int8 pLongAddress[8]; //EUI of ZigBee node
int8 nAging; //Aging time counter
} SOURCE_ADDRESS;
typedef struct {
int16 nShortID; //short ID of ZigBee node
int8 pLongAddress[8]; //EUI of ZigBee node
int8 pMAC[6]; //MAC address whether the ZigBee node from
int8 nAging; //Aging time counter
} SOURCE_ADDRESS;

Both address are dynamic which implemented by the aging time. Once the aging time couter become 0, the entry will be released. The aging time counter will be decreased in each specific period. It also will be set to maximum value when the entry is detect alive.

The source address table record the ZigBee node the bridge can received ZigBee packet through the ZigBee RF radio directly. When a new ZigBee packet comes, bridge will check the 802.15.4 AHR and see whether the source address is on source address table. If yes, then set the aging time couter of this node to maximum value. If no, then add the node to the table. The bridge need to update its source address table to other bridges once there is a update. The update can be new entry add or delete.

The destination address table record the ZigBee node the bridge should forward packet through powerline. When it sniffer a data, it should check the destination address table for where to forward the data.

Before Bridge A and Bridge B select a ZigBee network to bridge, they need to search which network they should bridge. So they will stay in one channel for a while and move to next channel. This is a loop and will be stop until find a network to bridge. When the bridges stay in a channel, they will sniffer ZigBee data and forward to power line based on source address table only.

Since the solution is bridging one ZigBee network transparently through PLC, it does not need to care about channel switching, panID changing or shortID changing, which happened under scope of ZigBee specification.

In an example, the present invention relates to power meter techniques. In particular, the present invention provides a method and system for extending the automatic meter infrastructure (AMI) for Smart Grid and Demand Response applications in multi-dwelling buildings and rural markets where the Smart Meter is located far away from the individual dwelling or house. More specifically, the present invention relates to the wireless and power-line carrier bridging techniques used to extend an AMI where the Smart Meter cannot connect to Home Area Network (HAN) devices such as in-home displays (IHDs), programmable communicating thermostats (PCTs), and load control switches inside a dwelling or home for power utilities to provide energy monitoring to customers and deploy demand response programs.

As background, conventional Smart Meter technology allows for a wireless connection to a home area network using ZigBee. Each conventional Smart Meter has a digital certificate, commonly called, elliptical curve certification, or “ECC.” In typical cases, a HAN device is configured to only a single Smart Meter with associated ECC.

In an example, the present invention can be combined using a variety of techniques, such as those described in any of the CROSS-REFERENCED applications. The present invention may be embodied as a wireless and power-line carrier bridge for extending an AMI. The system includes a wireless and power-line carrier bridging data concentrator that connects to a Smart Meter wirelessly and convert the signal to the existing AC wiring in the meter room. The system further includes another wireless and power-line carrier bridge that plugs into a standard AC wall outlet in the individual dwelling or house for converting the power-line carrier signal from the AC wiring to a wireless signal.

In a specific embodiment, the present invention provides a method for processing electrical use from a plurality of power meters. The method includes providing a data concentrator coupled to a power-line to ZigBeebridge and receiving an RX packet from a ZigBee network, which is coupled to at least one power meter. The method includes processing the RX packet to convert the RX packet in to an 802.15.4 ZigBee packet and processing the 802.15.4 ZigBee packet into a ZCL packet. The method includes processing the ZCL packet into a ZigBee packet; processing the ZigBee packet into an 802.3 Ethernet packet and processing the 802.3 Ethernet packet via a power line.

In a specific embodiment, the present invention provides a system for extending the Smart Meter's range to connect to Home Area Networks for energy monitoring and demand response in, for example, a home, buildings, apartments, hospitals, schools, factories, office buildings, industrial area setting and other regions. The system has a data concentrator. The data concentrator has a wireless communicating module configured to transmit and receive information at one or more first frequencies ranging up to 2.4 GHz, and a power-line module configured to transmit and receive information at one or more frequencies ranging from about 100 to 30 MHz. The data concentrator receives energy usage data, pricing, demand response events, and messaging from one or more Smart Meters and convert the wireless signal to a power-line carrier signal over the existing all three phases of the AC wiring. The system also includes a wireless and power-line carrier bridge that convert the power-line carrier signal back to a wireless signal to connect to various Home Area Network (HAN) devices, including but not limited to a programmable communicating thermostat (PCT), smart appliances and in-home display (IHD).

In one or more embodiments, the present invention provides a network infrastructure configured to connect to new smart meters to home area network (HAN) devices to enable remote control of appliances through the AMI. Of course, there can be other variations, modifications, and alternatives.

In an alternative embodiment, the present invention provides a method for converting a meter device into a smart meter. The method includes providing a meter device coupled to a building structure. The meter device comprises a metrology device capable of determining a power usage from at least a pair of powerlines. The metrology device is being coupled to at least the pair of power lines using a coupling device. The meter device comprises a serial port coupled to the metrology device. The method includes transferring an input signal from a serial port from the serial port of the metrology device to an interface device mechanically coupled to the meter device. The interface device comprises a processor device, which is configured to receive the input signal from the serial port. The method also processes the input signal from the serial port from a first format to a second format, which is a power line format in an analog signal or a digital signal. In an example, the power line format is selected from OFDM, FSK, and others.

Numerous benefits are achieved using the present invention over conventional techniques. The present invention maximizes the use of existing AC power lines of a home or building, provides a wireless extension for a smart meter to connect to devices in the home, and provide a backhaul wireless extension to connect to an AMI network. In a preferred embodiment, the present system provides a novel technique to communicate with one or more Smart Meters wirelessly and convert data over the existing AC power lines and revert the signal from the power lines back to a wireless network. In another preferred embodiment, the present system provides a novel technique to communicate with one or more smart meters from one type of wireless network to a power-line network and then to another type of wireless network. Depending upon the embodiment, one or more of these benefits may exist.

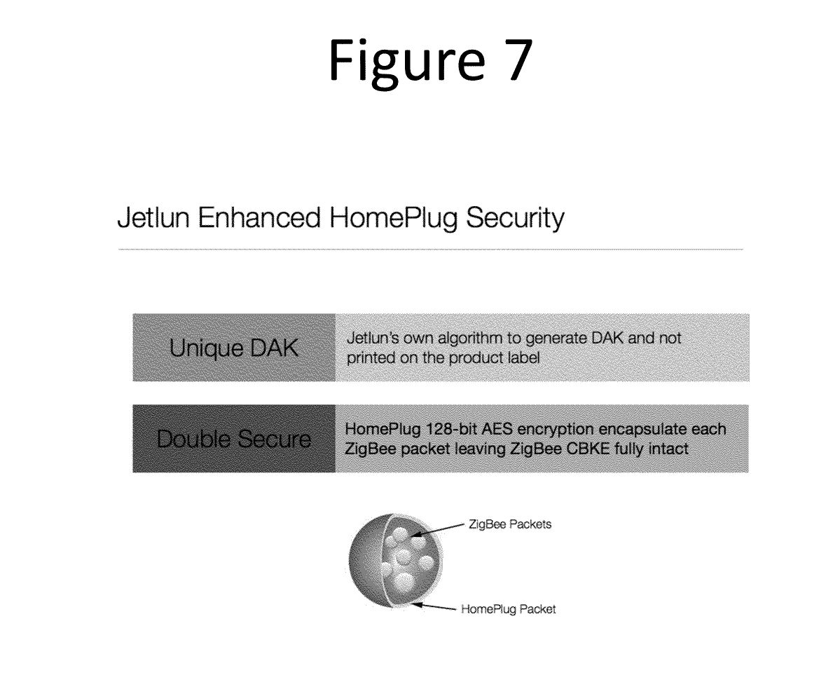

FIG. 7 is a simplified illustration of an encryption technique according to an embodiment of the present invention.

In an example, ZigBee networks are secured by 128 bit symmetric encryption keys. In home automation applications, transmission distances range from 10 to 100 meters line-of-sight, depending on power output and environmental characteristics. “ZigBee uses 128-bit keys to implement its security mechanisms. A key can be associated either to a network, being usable by both ZigBee layers and the MAC sublayer, or to a link, acquired through pre-installation, agreement or transport. Establishment of link keys is based on a master key which controls link key correspondence. Ultimately, at least the initial master key must be obtained through a secure medium (transport or pre-installation), as the security of the whole network depends on it. Link and master keys are only visible to the application layer. Different services use different one-way variations of the link key in order to avoid leaks and security risks. Key distribution is one of the most important security functions of the network. A secure network will designate one special device which other devices trust for the distribution of security keys: the trust center. Ideally, devices will have the trust center address and initial master key preloaded; if a momentary vulnerability is allowed, it will be sent as described above. Typical applications without special security needs will use a network key provided by the trust center (through the initially insecure channel) to communicate. Thus, the trust center maintains both the network key and provides point-to-point security. Devices will only accept communications originating from a key provided by the trust center, except for the initial master key. The security architecture is distributed among the network layers as follows:

The MAC sublayer is capable of single-hop reliable communications. As a rule, the security level it is to use is specified by the upper layers.

The network layer manages routing, processing received messages and being capable of broadcasting requests. Outgoing frames will use the adequate link key according to the routing, if it is available; otherwise, the network key will be used to protect the payload from external devices.

The application layer offers key establishment and transport services to both ZDO and applications. It is also responsible for the propagation across the network of changes in devices within it, which may originate in the devices themselves (for instance, a simple status change) or in the trust manager (which may inform the network that a certain device is to be eliminated from it). It also routes requests from devices to the trust center and network key renewals from the trust center to all devices. Besides this, the ZDO maintains the security policies of the device.

The security levels infrastructure is based on CCM*, which adds encryption- and integrity-only features to CCM.” See, Wikipedia.

In an example, “the HomePlug™ protocol can be, for example, the HomePlug Green PHY specification is a subset of HomePlug AV that is intended for use in the smart grid. It has peak rates of 10 Mbit/s and is designed to go into smart meters and smaller appliances such as HVAC thermostats, home appliances and plug-in electric vehicles so that data can be shared over a home network and with the power utility. High capacity broadband is not needed for such applications; the most important requirements are low power and cost, reliable communication, and compact size. GreenPHY uses up to 75 less energy than AV. The HomePlug Powerline Alliance worked with utilities and meter manufacturers to develop this 690-page specification. HomePlug Green PHY devices are required to be fully interoperable with devices based on HomePlug AV, HomePlug AV2 and IEEE 1901 specification.” See, Wikipedia.

Examples of various components that can be used are provided in U.S. Pat. No. 8,269,622, commonly assigned, and hereby incorporated by reference. The '622 patent is titled “Method and system for intelligent energy network management control system.” In an example, the aforementioned description can be used in conjunction with a system for providing network infrastructure for energy management and control is disclosed. A controller integrates powerline and wireless networking technologies in order to provide an integrated network. A gateway sends and receives command and control data across the integrated network. Client devices may connect to the integrated network and perform a variety of functions. An appliance module may send and receive data across the integrated network in relation to a particular appliance. A panel meter may send and receive data across the integrated network in relation to data measured at a distribution panel. A serial bridge may connect various devices to the integrated network. Computing devices may remotely or locally connect to the integrated network and send and receive data.

As preferred embodiment, the Zigbee chipset can feature an integrated Zigbee chipset manufactured by EMBER CORPORATION of Massachusetts, according to an embodiment of the present invention, but it would be recognized that other chipsets could be utilized such as wireless chipsets for RF signals, WiFi, ZigBee, Bluetooth, WPAN, RFID, UWB, infrared (IR), or other media. In alternative embodiments, the Zigbee wireless chipset can include other chipset designs that are suitable for the present methods and systems such as other Zigbee chipsets from suitable companies such as TI, Freescale, or others, as well as other wireless networking technologies that are suitable for the present methods and systems such as 61oWPAN, WiFi 802.11, Bluetooth, RFID, and UWB network chipsets from Archrock, Broadcom, Atheros, or others. As noted, the chipsets and companies mentioned are merely an example and should not unduly limit the scope of the claims herein.

As a preferred embodiment, the powerline chipsets may feature an integrated powerline chipset manufactured by YITRAN of Israel, according to an embodiment of the present invention, but it would be recognized that other chipsets could be utilized. Powerline chipsets may be embodied in a variety of chipsets optimized for coupling and communicating across HomePlug systems, copper wiring, premises wiring, co-axial cables, or telephone cables within the network infrastructure managed by gateway. As a preferred embodiment, the powerline chipset may be a single-chip powerline networking controller with integrated Simple serial Host interface (logical command language over UART). The chip interfaces with RS232 serial interfaces, among others. Preferably, there is at least a 7.5 kbps data rate on the premises wiring or AC wiring, although others may be desirable, such as 1 Mbps, 14 Mbps, 85 Mbps, 400 Mbps and 1 Gbps.

In alternative embodiments, the powerline chipset can include other chipset designs that are suitable for the present systems such as other powerline chipsets from suitable companies such as DS2, Intellon, Panasonic, Coppergate, Sigma, Arkados, Yitran, Echelon, or others, as well as other networking technologies that are suitable for the present methods and systems such as HomePNA, MoCA, and UWB network chipsets from Coppergate, Entropic, or others. As noted, the chipsets and companies mentioned are merely an example and should not unduly limit the scope of the claims herein.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A transparent networking system for energy management within a network, the system comprising:
a single transparent meshed communication network comprising:
a first ZigBee network provided within a first spatial region, the first spatial region being within a confinement of a first thirty meter range;
a second ZigBee network provided within a second spatial region, the second spatial region being with a confinement of a second thirty meter range;
a powerline carrier configured between the first ZigBee network and the second ZigBee network to facility transfer of bi-directional information packet by packet between the first ZigBee network and the second ZigBee networks; and
an encryption configured in a powerline format for the bi-directional information, the powerline format being a 128 bit AES encryption to encapsulate the bi-directional information packet by packet; each of the packets having a ZigBee CBKE intact; and
whereupon the 128 bit AES encapsulating each of the packets configuring the ZigBee CBKE intact.

2. The system of claim 1 wherein the first ZigBee network comprising a plurality of first ZigBee enabled devices and wherein the second ZigBee network comprising a plurality of second ZigBee enabled devices; wherein the confinement is greater than a thirty meter range; wherein the powerline format is a Homeplug™ format.

3. The system of claim 1 further comprising an Nth ZigBee network, where N is an integer greater than 2, and an Nth powerline carrier configured to the first ZigBee network and the second ZigBee network.

4. The system of claim 1 wherein the first ZigBee network comprising a plurality of first ZigBee enabled devices and wherein the second ZigBee network comprising a plurality of second ZigBee enabled devices, each of the plurality of first ZigBee enabled devices being configured to communicate with any one of the second plurality of ZigBee enabled devices.

5. The system of claim 1 wherein the transfer of the bi-direction information packet by packet is provided in a PHY/MAC layer of the powerline carrier.

6. The system of claim 1 wherein the bi-directional information maintains a 802.15.4 header in an address table.

7. The system of claim 1 wherein the powerline carrier is configured to identify either the first ZigBee network or the second ZigBee network.

8. The system of claim 1 wherein the first ZigBee network comprises a first powerline transceiver coupled to a first ZigBee transceiver; and wherein the second ZigBee network comprises a second powerline transceiver coupled to a second ZigBee transceiver.

9. The system of claim 1 wherein the first ZigBee network maintains each of source addresses from the first ZigBee network and each of destination addresses for the second ZigBee network; wherein the second ZigBee network maintains each of source addresses from the second ZigBee network and each of destination addresses for the first ZigBee network.

10. A transparent networking system for meter infrastructure within a network, the system comprising:
a single transparent meshed communication network comprising:
a first ZigBee network provided within a first spatial region, the first spatial region being within a confinement of a first spatial meter range;
a second ZigBee network provided within a second spatial region, the second spatial region being with a confinement of a second spatial meter range;
a powerline carrier configured between the first ZigBee network and the second ZigBee network to facility transfer of bi-directional information packet by packet between the first ZigBee network and the second ZigBee networks.

11. The system of claim 11 wherein the first ZigBee network comprising a plurality of first ZigBee enabled devices and wherein the second ZigBee network comprising a plurality of second ZigBee enabled devices.

12. The system of claim 11 further comprising an Nth ZigBee network, where N is an integer greater than 2, and an Nthpowerline carrier configured to the first ZigBee network and the second ZigBee network.

13. The system of claim 11 wherein the first ZigBee network comprising a plurality of first ZigBee enabled devices and wherein the second ZigBee network comprising a plurality of second ZigBee enabled devices, each of the plurality of first ZigBee enabled devices being configured to communicate with any one of the second plurality of ZigBee enabled devices.

14. The system of claim 11 wherein the transfer of the bi-direction information packet by packet is provided in a PHY/MAC layer of the powerline carrier.

15. The system of claim 11 wherein the bi-directional information maintains a 802.15.4 header in an address table.

16. The system of claim 11 wherein the powerline carrier is configured to identify either the first ZigBee network or the second ZigBee network.

17. The system of claim 11 wherein the first ZigBee network comprises a first powerline transceiver coupled to a first ZigBee transceiver; and wherein the second ZigBee network comprises a second powerline transceiver coupled to a second ZigBee transceiver.

18. The system of claim 11 wherein the first ZigBee network maintains each of the addresses for a plurality of second plurality of ZigBee enabled devices; wherein the second ZigBee network maintains each of the addresses for a plurality of first ZigBee enabled devices.

19. A method for communicating within a single transparent meshed network comprising:
initializing a first sniffer device in the first ZigBee network;
initializing a second sniffer device in the second ZigBee network;
initializing a first powerline driver;
initializing a second powerline driver;
scanning the first ZigBee network through a plurality of first channels using a first switching operation;
selecting a first channel for the first ZigBee network by the first switching operation through the plurality of channels, the first channel being from the plurality of channels in the first ZigBee network;
scanning the second ZigBee network through a plurality of second channels using a second switching operation;
selecting a second channel for the second ZigBee network by the second switching operation through a plurality of channels, the second channel being from the plurality of channels in the second ZigBee network, the second channel being the same as the first channel;
recording information from the first ZigBee network;
recording information from the second ZigBee network;
sniffing each of the first ZigBee network and the second Zigbee network;
receiving a data packet from a first ZigBee enabled device within the first ZigBee network;
checking the data packet to parse a header of the data packet to determine whether to forward the data packet by comparing a plurality of entries in an address table of the first ZigBee network;
transferring the data packet from the first ZigBee network to the second ZigBee network using a powerline carrier through a PHY/MAC layer.

20. The method of claim 19 further comprising:
checking PLC data from the powerline carrier to parse a header of the data packet and forward the data packet to a second Zigbee enabled device in the second ZigBee network.

21. The method of claim 19 further comprising:
checking PLC data from the powerline carrier to parse a header of a data packet from a second Zigbee enabled device in the second ZigBee network; and
forwarding the data packet to one of the first ZigBee enabled devices.
